(19) United States
(12) Patent Application Publication
(10) Pub. No.: US 2026/0178934 A1
(43) Pub. Date: Jun. 25, 2026

(54) HYBRID MACHINE LEARNING SYSTEM FOR EFFICIENT OPERATION REVIEW WITH ANOMALY DETECTION, ADAPTIVE CONFIDENCE SCORING, AND MULTI-LAYERED CONTEXTUAL RISK SCORING

(71) Applicant: Citibank, N.A., New York, NY (US)

(72) Inventors: Miriam Silver, Herzliya (IL); Girish Wali, Flower Mound, TX (US); Prasanth Babu Madakasira Ramakrishna, Flower Mound, TX (US)

(21) Appl. No.: 18/443,725

(22) Filed: Feb. 16, 2024

Related U.S. Application Data
(63) Continuation-in-part of application No. 18/368,750, filed on Sep. 15, 2023, now abandoned.

(51) Int. Cl. G06N 5/022

(52) U.S. Cl. CPC G06N 5/022

(57) ABSTRACT

Systems and methods may validate operation request data associated with operations requested or triggered by maker-user inputs. A computing device can execute software routines and/or one or more machine-learning architectures to obtain one or more operation records for an operation from one or more data sources; extract a feature vector for the operation based upon a plurality of operation features extracted using the one or more operation records for the operation; determine an operation type for the operation by applying a classifier of a machine-learning architecture on the feature vector for the operation; generate a risk score for the operation by applying a risk model of the machine-learning architecture on the operation feature vector and the operation type; determine one or more authorization thresholds for the operation based upon the risk score; and transmit the operation record to one or more checker client devices corresponding to the authorization thresholds.

### TECHNICAL FIELD

This application generally relates to validating operations, which may generally include routing an operation request and related operation data to a checker device, prior to executing requested or triggered operations.

### BACKGROUND

Human errors are inevitable in any system in which humans are involved in data entry or drafting, such as software code written by software developers, customer data entered by users for financial transactions or e-commerce operations, or end-user data entered by users for non-financial transactions or updating user profile data. In software coding efforts, these errors can lead to ineffective or inefficient software operations or delayed software development projects. In financial transactions, these errors can lead to significant losses and/or overlook fraudulent activities for financial institutions and the customers. In other computing systems that conduct non-financial operations and/or rely upon end-user data profiles, data entry errors can likewise lead to poor performance and inefficiencies.

Computing systems often include user interfaces allowing data entry users (or “makers”) to enter data, and then trigger or request certain operational functions based on the entered data, such as finalizing or committing software code to a finished codebase. Likewise, computing systems often include user interfaces allowing for users (or “checkers”) or conduct quality assurance or review of the data entered before software programs of the system execute the requested operations. Checkers help catch inaccuracies like coding errors, data entry mistakes, calculation errors, and misplaced decimal points, ensuring that, for example, the software code, financial records, end-user profile data, or any other types of data, are accurate and reliable. Checkers also help identify and prevent fraudulent activities such as embezzlement, unauthorized transactions, and identity theft. By scrutinizing the data entered by the maker and analyzing other types of data from other data sources, such as operations, a checker may detect unusual patterns or suspicious behavior can be detected early, minimizing the impacts of errors (e.g., code errors propagating throughout the codebase, minimizing financial losses).

In addition, the being entered may be subject to certain standards. As an example, software code may be subject to industry coding standards or internal corporate standards, governing the formatting of the data or the functions that may be executed by the software program. As another example, financial transactions may be subject to various laws, regulations, and industry standards. Checkers ensure that the software code or requested operations comply with these requirements, helping software developers or financial institutions avoid, for example, legal penalties and reputational damage. For businesses, internal control mechanisms are used to prevent misuse of funds, unauthorized access, and other internal breaches. Checkers contribute to these controls by verifying that operations align with established policies and procedures.

However, human checkers are just as prone to errors as those initiating the operation (“makers”). Therefore, a robust and comprehensive approach to minimize errors in operation data before performing related operations is needed.

### SUMMARY

Existing systems frequently require human users to manually enter and review information received via a user interface of a client device in order for the system to perform certain operations, such as updating software codes or performing new operations. As an example, in a financial use case, a “maker” enters the operation information into a user interface for initiating the operation, and the operation information is stored into an operation record. A “checker” performs a manual quality control review of the operation record to confirm whether to revise or execute the requested operation. These manual processes can be time and resource intensive, inject errors into the operation, and fail to catch errors. Even when errors are identified, it can be time-consuming and embarrassing to revise the operation information.

Disclosed herein are systems and methods capable of addressing the above-described shortcomings and may also provide any number of additional or alternative benefits and advantages. Embodiments include a computing device that executes software routines and/or one or more machine-learning architectures that apply the machine-learning architecture on operation information to reduce errors. The machine-learning architecture is trained on historical maker and checker data associated with a variety users and types of operations, to generate a risk score for an operation. The risk score indicates the level-of-criticality of the operation and the likelihood of error for the new operation. Based on the risk score, the system routes the operation record for the new operation to one or more checkers to conduct manual review/authorization and other possible automated review processes. The machine-learning architecture includes a classifier that determines or predicts the type of operation involved and classifies whether the type of operation is, for example, “financial” or “non-financial.” To generate the risk score, the machine-learning architecture classifies or clusters the features and feature vectors of the operation information of the new operation with similar feature vectors or vector clusters generated from the historic operation data. The risk score is determined based upon a distance from the operation information's features to the clusters of the historic operation data. The operation classification could be used to select certain clusters of historic operations and/or the operation classification could be used to adjust the risk score. Additional feature sets would employ the machine-learning architecture would automate the maker and checker processes for ingesting and reviewing operation information.

Accurately checking (e.g., validating, authorizing, reviewing, etc.) operations could be improved by employing machine-learning architecture to better predict a risk of operations and then appropriately route the operation to one or more specific checkers that are most likely to identify and correct the likeliest of errors in the operation, based at least on the predicted risk of the operation.

In an embodiment, a computer-implemented method may comprise obtaining, by the computer, a request for an operation and operation data inputs via a user interface of a maker client device; obtaining, by the computer, one or more operation data records associated with the operation indicated by the request from one or more data sources; extracting, by the computer, a feature vector for the operation based upon a plurality of operation features extracted using the operation data including the one or more operation data records and the operation data inputs for the operation; determining, by the computer, an operation-type for the operation by applying a classifier of a machine-learning architecture on the feature vector for the operation; generating, by the computer, a risk score for the operation by executing a risk-scoring engine of the machine-learning architecture on the feature vector and an operation-type of the operation; determining, by the computer, one or more authorization thresholds for the operation based upon the risk score and the operation-type; transmitting, by the computer, the operation data to one or more checker client devices corresponding to the one or more authorization thresholds based on the risk score by executing a routing engine trained for routing the operation data to one or more computing devices; and retraining, by the computer, the routing engine of the machine-learning architecture by adjusting one or more parameters of the routing engine according to a feedback input obtained via an administrative user interface.

The computer may be further configured to receive from a maker client device, one or more maker inputs indicating the one or more operation records for the operation.

The computer may train the classifier of the machine-learning architecture to determine the operation type by applying the classifier of the machine-learning architecture on a plurality of historic operation records, each historic operation record having a training label indicating the operation type.

The computer may be further configured to execute the operation, responsive to the computer receiving an indication of authorization from the one or more checker client devices.

The computer may be further configured to apply the risk model of the machine-learning architecture on historical data to generate the risk score, wherein the historical data includes error data associated with one or more operation features of the feature vector.

The computer may be further configured to apply a routing model of the machine-learning architecture on historical data and the risk score to determine the one or more authorization thresholds.

The risk score may indicate at least one of a probability of one or more errors in the one or more operation records or a level of risk associated with the operation.

In another embodiment, a server may comprise a processor for executing machine-readable instructions, the server configured to: obtain a request for an operation and operation data inputs via a user interface of a maker client device; obtain one or more operation data records associated with the operation indicated by the request from one or more data sources; extract a feature vector for the operation based upon a plurality of operation features extracted using the operation data including the one or more operation data records and the operation data inputs for the operation; determine an operation-type for the operation by applying a classifier of a machine-learning architecture on the feature vector for the operation; generate a risk score for the operation by executing a risk-scoring engine of the machine-learning architecture on the feature vector and an operation-type of the operation; determine one or more authorization thresholds for the operation based upon the risk score and the operation-type; transmit the operation data to one or more checker client devices corresponding to the one or more authorization thresholds based on the risk score by executing a routing engine trained for routing the operation data to one or more computing devices; and retrain the routing engine of the machine-learning architecture by adjusting one or more parameters of the routing engine according to a feedback input obtained via an administrative user interface.

The server may be further configured to receive, from a maker client device, one or more maker inputs indicating the one or more operation records for the operation.

The server may be further configured to train the classifier of the machine-learning architecture to determine the operation type by applying the classifier of the machine-learning architecture on a plurality of historic operation records, each historic operation record having a training label indicating the operation type.

The server may be further configured to execute the operation, responsive to the server receiving an indication of authorization from the one or more checker client devices.

The server may be configured to apply the risk model of the machine-learning architecture historical data to generate the risk score, wherein the historical data includes error data associated with the one or more of operation features of the feature vector.

The server may be configured to apply a routing model of the machine-learning architecture is applied to historical data and the risk score to determine the one or more authorization thresholds.

The risk score may indicate at least one of a probability of one or more errors in the one or more operation records or a level of risk associated with the operation.

In yet another embodiment, a computer-readable medium may comprise a non-transitory storage memory configured to store machine-readable instructions that when executed by a processor instruct the processor to: obtain a request for an operation and operation data inputs via a user interface of a maker client device; obtain one or more operation data records associated with the operation indicated by the request from one or more data sources; extract a feature vector for the operation based upon a plurality of operation features extracted using the operation data including the one or more operation data records and the operation data inputs for the operation; determine an operation-type for the operation by applying a classifier of a machine-learning architecture on the feature vector for the operation; generate a risk score for the operation by executing a risk-scoring engine of the machine-learning architecture on the feature vector and an operation-type of the operation; determine one or more authorization thresholds for the operation based upon the risk score and the operation-type; transmit the operation data to one or more checker client devices corresponding to the one or more authorization thresholds based on the risk score by executing a routing engine trained for routing the operation data to one or more computing devices; and retrain the routing engine of the machine-learning architecture by adjusting one or more parameters of the routing engine according to a feedback input obtained via an administrative user interface.

The processor may be further instructed to receive, from a maker client device, one or more maker inputs indicating the one or more operation records for the operation.

The processor may be further instructed to train the classifier of the machine-learning architecture to determine the operation type by applying the classifier of the machine-learning architecture on a plurality of historic operation records, each historic operation record having a training label indicating the operation type.

The processor may be further instructed to execute the operation responsive to receiving, from the one or more checker client devices, an indication of authorization.

The processor may be further instructed to apply the risk model of the machine-learning architecture on historical data to generate the risk score, wherein the historical data includes error data associated with one or more of operation features of the feature vector.

The risk score may be associated with a probability of one or more errors in the one or more operation records.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a block diagram of a network environment, in accordance with one or more embodiments.

FIG. 2 shows dataflow amongst components of a system, in accordance with one or more embodiments.

FIG. 3 shows data flow among executable software components of a machine-learning architecture, according to an embodiment.

FIG. 4 is a flowchart illustrating operations of a method for validating a financial operation, in accordance with one or more embodiments.

FIG. 5 is a flowchart illustrating operations of a method for training a machine learning model with training records, in accordance with one or more embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Traditionally, human users manually entered and reviewed operation information for new operations. A “maker” would initiate an operation by entering the operation information, which would be stored into an operation record. A “checker” would perform a manual quality review of the operation information before the operation was executed using the operation record. In some instances, the checker would find errors in the maker's operation record and either reject the operation or correct the error. This maker-checker bifurcation allowed for validation of the operation before software application(s) of a computing system would execute an incorrect operation. However, due to inevitable human fallibility, this traditional maker-checker bifurcation does not correct all errors. This leads to incorrectly executed operations, which may result in costly consequences. In some instances, certain makers and checkers are more prone to error than others; and some operations are more prone to errors than others.

While financial transactions or financial operations by computing software and users of financial institutions are discussed generally in this disclosure, it should be understood that the present disclosure relates to both financial and non-financial operations by financial institutions or other entities more generally.

The solutions presented herein may utilize machine-executed software programming for a machine-learning architecture having any number of models trained to intelligently route operations to checkers. The machine-learning architecture may include an operation-type engine, a risk engine, and a routing engine (“engines”). Some embodiments of the machine-learning architecture may include a plurality of distinct machine-learning architectures executed by one or more computing devices configured to perform the functions described herein. The machine-learning architectures may include any number and combination of machine-learning techniques or types of machine-learning structures, such as neural network architectures and Gaussian Mixture Models (GMMs), among others. For ease of description, the operations of a particular machine-learning architecture are described as “layers,” though the machine-learning architecture need not be a neural network architecture.

The engines may record and/or ingest operation data across time and place and use this operation data to train the engines. The engines may be used to determine the type of operation associated with a newly initiated operation. The engines may be trained to determine and/or predict a risk of the newly initiated operations having an error and intelligently route the newly initiated operation to one or more checkers based on at least the predicted risk. The engines may predict the risk of the newly initiated operation based on the type of operation (e.g., transfer of funds, change of beneficiary, financial dispute, etc.), the operative parameters of the operation (e.g., the amount of a transaction, the timing of the operation, the parties to the operation, etc.), and/or various historical data (e.g., history of errors of the maker/checker, history of errors in the type of operation, trends of operations, etc.).

By way of example, the newly initiated operation may be for a transfer of $1,000,000 from the maker (e.g., sender account-holder of financial institution) to a second user (e.g., receiver of funds transfer). The operation type may be predicted by the operation-type engine based on the maker of the newly initiated operation and/or the details of the newly initiated operation. For example, the model may predict that the operation is a transfer of funds due to a currency amount and a designation of “sender” and “receiver” in an operation record of the newly initiated operation. The risk associated with the newly initiated operation may then be predicted by the risk engine based on the predicted type of operation (e.g., transfer of funds), the operative parameters of the operation (e.g., $1,000,000 from the maker to the second user), and/or historical data (e.g., the number of errors in the maker's previous operations).

In the above example, the risk engine may determine/predict that the newly initiated operation is a high-risk operation based on the amount of the transfer (e.g., $1,000,000). In another example, the risk engine may determine/predict that the newly initiated operation is a high-risk operation based on the maker if the maker has a history of making errors, even if the amount of the transfer is relatively low (e.g., $100).

Once the risk engine determines/predicts the risk associated with the newly initiated operation, a routing engine automatically determines one or more checker routes for the newly initiated operation to be routed to prior to executing the operation. The risk engine may then automatically route the operation based on determined one or more checker routes. In some embodiments the newly initiated operation need not be routed to a checker if the operation's associated risk is below a predefined threshold and/or the model has a confidence level above a predefined threshold.

### Example System Components

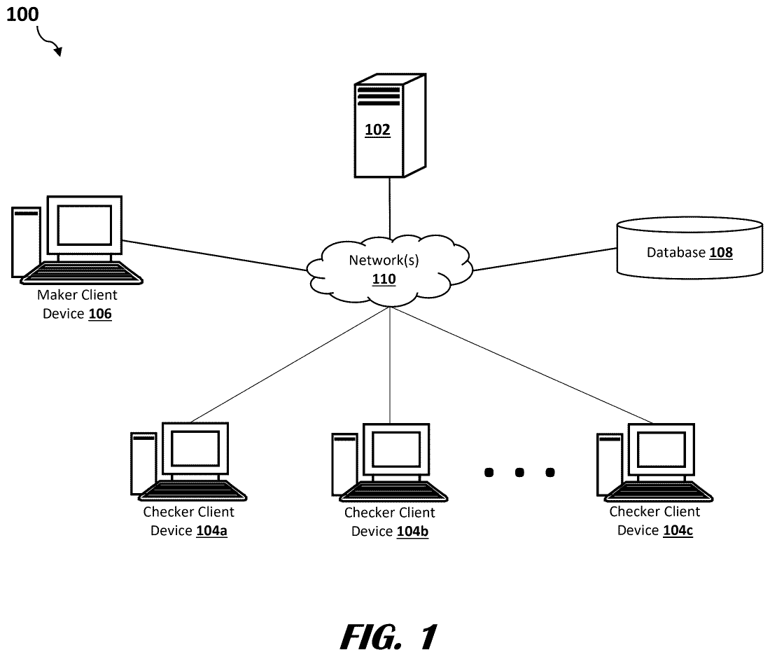

FIG. 1 shows components of a system 100 for routing operations from a maker client device 106 to a checker client devices 104a-104c, according to an embodiment. The system 100 may include an analytics server 102, a database 108, the maker client device 106, and the checker client devices 104a-104c. The various devices of the system 100 may communicate with one another via one or more networks 110.

For ease of description and understanding, FIG. 1 depicts the system 100 as having only one or a small number of each component. Embodiments may, however, comprise additional or alternative components, or omit certain components, from those of FIG. 1 and still fall within the scope of this disclosure. As an example, it may be common for embodiments to include multiple analytics servers 102 and/or multiple databases 108. Embodiments may include or otherwise implement any number of devices capable of performing the various features and tasks described herein. For instance, FIG. 1 depicts the database 108 as hosted as a distinct computing device from the analytics server 102, though, in some embodiments, the analytics server 102 may include an integrated database 108 hosted by the analytics server 102.

The system 100 includes one or more networks 110, which may include any number of internal networks, external networks, private networks (e.g., intranets, VPNs), and public networks (e.g., Internet). The networks 110 comprise various hardware and software components for hosting and conduct communications amongst the components of the system 100. Non-limiting examples of such internal or external networks 110 may include a Local Area Network (LAN), Wireless Local Area Network (WLAN), Metropolitan Area Network (MAN), Wide Area Network (WAN), and the Internet. The communication over the networks 110 may be performed in accordance with various communication protocols, such as Transmission Control Protocol and Internet Protocol (TCP/IP), User Datagram Protocol (UDP), and IEEE communication protocols, among others.

The maker client device 106 may be any type of electronic device comprising hardware components (e.g., processor, non-transitory storage) and software components capable of performing the various processes and tasks described herein. Non-limiting examples of the maker client device 106 include personal computers (e.g., laptop computers, desktop computers), server computers, mobile devices (e.g., smartphones, tablets), VR devices, and gaming consoles, among other types of electronic devices.

The checker client devices 104a-104c may be any type of electronic device comprising hardware components (e.g., processor, non-transitory storage) and software components capable of performing the various processes and tasks described herein. Non-limiting examples of the checker client devices 104a-104c include personal computers (e.g., laptop computers, desktop computers), server computers, mobile devices (e.g., smartphones, tablets), VR devices, and gaming consoles, among other types of electronic devices.

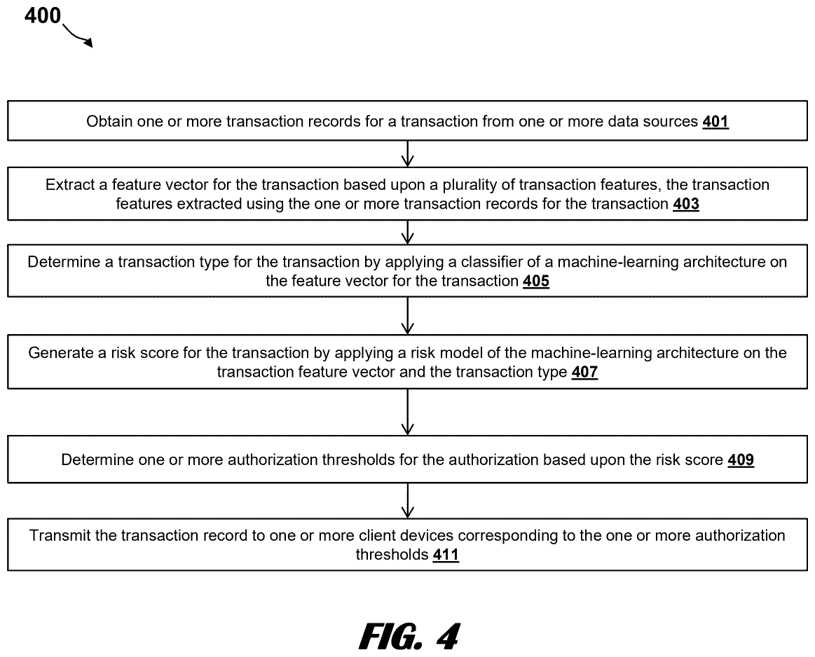

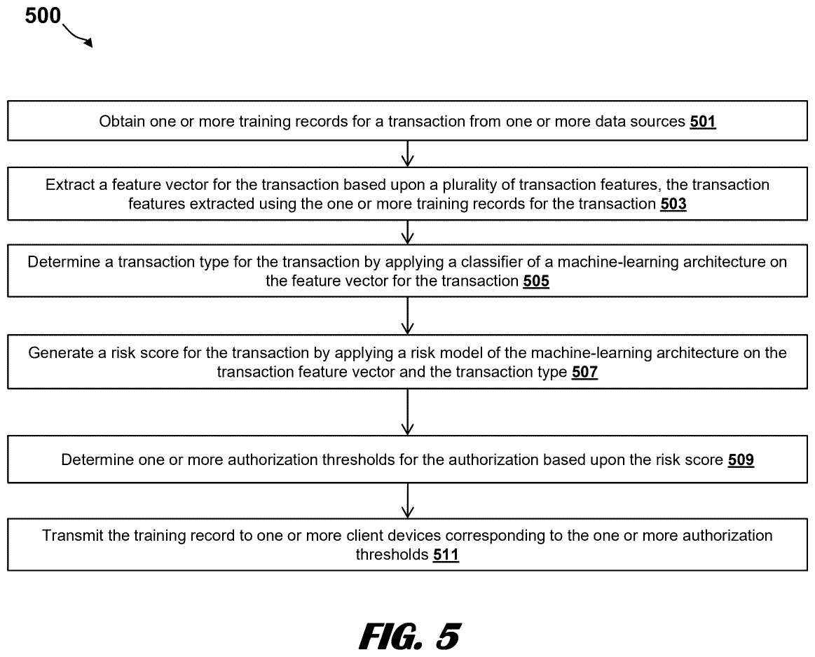

The analytics server 102 may execute one or more software programs to perform various methods and processes (e.g., the processes 400-500 of FIGS. 4-5). The analytics server 102 may include one or more computing devices configured to perform various processes and operations disclosed herein. In some embodiments, the analytics server 102 may be a computer or computing device capable of performing methods disclosed herein. The analytics server 102 may include a processor and non-transitory, computer readable medium including instructions, which, when executed by the processor, caused the processor to perform methods disclosed herein. The processor may include any number of physical, hardware processor. Although FIG. 1 shows only a single analytics server 102, the analytics server 102 any include any number of computing devices. In some cases, the computing devices of the analytics server 102 may perform all or portions of the processes and benefits of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the maker client device 106 or checker client devices 104a-104c.

The analytics server 102 may also be configured to execute software routines that perform various types of data analysis that include machine learning (or artificial intelligence) architectures containing various layers and functions for risk predictions of operations. These software routines and operations may define the various layers, models, and functions of the machine-learning architecture and causes the analytics server 102 apply various machine-learning structures or techniques, such as a Gaussian Mixture Matrix (GMM), neural network (e.g., convolutional neural network, deep neural network), and the like. The machine-learning architecture comprises functions or layers that define or perform the functions of, for example, an operation-type engine, a risk engine, and a routing engine, among others (e.g., error correction, error detection). As mentioned, the analytics server 102 may execute any number of machine-learning architectures having any number of layers, though for ease of description the analytics server 102 executes a single machine-learning architecture.

The machine-learning architecture operates logically in several operational phases, including a training phase, an optional enrollment phase, and a deployment phase (sometimes referred to as a “test phase” or “testing”). Some embodiments need not perform the enrollment phase for developing certain components of the machine-learning architecture. The analytics server 102 receives input operation records corresponding to the particular operational phase of the machine-learning architecture, include training operation records during the training phase, enrollment operation records during the enrollment phase, and newly initiated operation records during the deployment phase. The analytics server 102 applies certain layers of the machine-learning architecture to each type of operation signal during the corresponding operational phase. In some embodiments, the analytics server 102 receives inputs other than operation records (e.g., routing protocol data, historical error data, etc.).

In some implementations, the analytics server 102 may include one or more input layers to ingest data when executing the machine-learning architectures. For example, the analytics server 102 may be communicably coupled to the database 108 to receive data (e.g., training data, historical data, current operation records, etc.) to be used in training and/or deploying the analytics server 102.

During a training phase, the analytics server 102 receives training data, including training labels (e.g., metadata) and historic operation records and data. In some cases, the analytics server 102 generates various simulated training operation records. The layers of the machine-learning architecture may extract various training features and training feature vectors from the entries of the training data. During training, the analytics server 102 applies and tunes the various components of the machine-learning architecture (e.g., operation-type engine, risk engine, routing engine) on these training feature vectors. The analytics server 102 applies the various layers of the machine-learning architecture on the training features to predict various features or outcomes associated with the training operation records. For example, the analytics server 102 may apply the operation-type engine to predict a type of operation associated with each particular training operation record, using the training feature vector extracted for the particular training operation record. In some embodiments, the analytics server 102 may apply the risk score engine on the training operation record to predict a probability of error in the training operation record and/or a severity of risk should an error exist in the training operation record, using the training feature vector extracted for the particular training operation record. In some embodiments, the analytics server 102 may apply the routing engine on the training features to predict an authorization threshold and/or compare the risk score to the authorization threshold to predict one or more checker client devices 104a-104c to which to route the training operation record, using the training feature vector extracted for the particular training operation record.

Loss layers or another aspect of the machine-learning architectures determine a level of training-error (e.g., one or more similarities, distances, etc.) between the predicted output and labels or other data indicating the expected output (e.g., expected vectors; expected classifications; expected risk scores; expected authorization routes). The loss layers or another aspect of the machine-learning architecture adjusts the hyper-parameters until the level of error for the predicted outputs satisfy a threshold level or error with respect to expected outputs. The analytics server 102 then stores the hyper-parameters, weights, or other aspects of the particular machine-learning architecture, thereby “fixing” the particular component (e.g., operation-type engine, risk engine, routing engine) of the machine-learning architecture.

The database 108 may contain any number of corpora of training records (e.g., financial and non-financial) that are accessible to the analytics server 102 over internal networks or networks 110. In some implementations, the analytics server 102 employs supervised training to train the machine-learning architecture, where the database 108 includes training labels associated with the training records that indicate, for example, characteristics or features of the training records. Other implementations may employ other types of training techniques, including unsupervised or semi-supervised training, such as clustering. Additionally, or alternatively, the analytics server 102 may query an external third-party database (not shown) to access a corpus of one or more training records. In some cases, an administrator of the system 100 may configure the analytics server 102 to select the training records having certain features or characteristics.

During the deployment phase, the analytics server 102 receives one or more operation records associated with the operation from the maker client device 106. The one or more operation records may be received from maker client device 106 (e.g., data inputted into an electronic form at the maker client device 106), the database 108 (e.g., stored historical/client data), the checker client devices 104a-104c, other servers, other databases, and/or any other electronic device. The operation records may include data inputted at the maker client device 106 corresponding to operative parameters of the operation (e.g., maker of the operation, sender of the operation, receiver of the operation, amount of the operation, type of the operation, date of the operation, time of the operation, accounts associated with the operation, beneficiaries of the operation, parties to the operation, notes on the operation, instructions for the operation, operation identifier, etc.); stored and/or transmitted personally identifiable information associated with the one or more parties associated with the operation (e.g., full name, social security number, driver's license number, passport number, email address, physical address, phone number, date of birth, and biometric information such as fingerprints or facial recognition data, credit card numbers, bank account details, personal health information); and/or institutional database records associated with the operation (e.g., types of operations available, attributes of types of operations, institutional protocols associated with operations, etc.). The analytics server 102 applies the various components of the machine-learning architectures to extract various operation features from the operation record. The analytics server 102 applies one or more classifiers to the one or more operation records to generate a single (or multiple) feature vector for the operation. The feature vector for the operation may be generated based on a single operation record or from multiple operation records.

The operation-type engine of the machine-learning architecture determines or predicts one or more operation types to associate with the operation, based at least on the generated feature vector for the operation. In some embodiments, the feature vector for the operation is generated by the operation-type engine, however the feature vector may be generated by any of the described engines or layers of the machine-learning architecture or may be generated by one or more other unique layers. In some implementations, the operation-type engine comprises layers defining a classifier for determining or predicting the type or classification of the operation. In classifying the operation as being associated with one or more operation types, the operation-type engine generates an operation score to associate with the operation based on one or more operation features of the feature vector for the operation. The generated operation score may then be compared, by the operation-type engine to one or more operation thresholds to determine whether or not the operation score satisfies (e.g., exceeds) the one or more thresholds. Each possible operation may have an associated operation threshold (or threshold range) which the operation score may need to satisfy in order to be classified as that operation. If the operation score of the operation satisfies the operation threshold, the operation-type engine may determine that that the operation is of the operation type associated with the operation threshold. In some embodiments, the operation-type engine generates an operation-type confidence score after determining the operation type. The operation-type confidence score may indicate the likelihood that the operation-type engine's determination is correct, based on operation features of the feature vector for the operation. In some embodiments, the operation-type confidence score must satisfy an operation-type confidence threshold prior to the operation-type engine determining the operation type associated with the operation. If the operation-type engine is unable to determine an operation type associated with the operation with an operation-type confidence score satisfying the operation-type confidence threshold, the routing engine (described herein) may route to one or more checker client device 104a-104c the one or more operation records of the operation, the likeliest operation type associated with the operation, and an indication of the operation-type confidence score of the likeliest operation type.

In some embodiments, the feature vector may include an explicit operation-type feature defining the operation type. The operation-type engine may apply one or more layers to extract the operation-type feature in order to classify the operation. However, in some embodiments, the feature vector for the operation may not include the operation-type feature. In such embodiments, the operation-type engine determines the operation type based on one or more other features of the feature vector. By way of example, the operation-type engine may determine an operation score associated with a change of beneficiary for a retirement account based on the feature vector including a current beneficiary, a proposed beneficiary, and a retirement account data. In such an embodiment, although the feature vector does not include a specific indication of the operation-type feature, the operation-type engine is able to determine that the operation associated with the feature vector is a change of beneficiary operation based on the existence of the various other operation features of the feature vector (e.g., the current beneficiary, the proposed beneficiary, and the retirement account data).

The risk engine of the machine-learning architecture determines the risk score associated with the operation, indicating the likelihood of accuracy of the maker and/or checker. Additionally, or alternatively, in some cases, the risk score indicates a level of criticality or importance of the operation (e.g., for instance, based upon certain types of operations) or the risk score is adjusted based upon the criticality of the operation. For instance, upon determining the operation type associated with the operation, the analytics server 102 may apply a risk engine of the machine-learning architecture to determine a risk score associated with the operation. The risk score may indicate a likelihood (e.g., probability) that the one or more operation records contain one or more errors. In some embodiments, the risk score may also include an indication of a severity of consequence that an error (however probable) in the one or more operation records may have on a party associated with the operation (e.g., a sender, a receiver, a beneficiary, an owner, a financial institution, etc.). The risk score may then be used by the routing engine (as applied by the analytics server 102 of FIG. 1 and described herein) to determine one or more checker client devices 104a-104c to which to route the one or more operation records.

The risk engine may ingest the one or more operation records previously received by the operation-type engine. Additionally, or alternatively, the risk engine applies various functions or layers to receive, from the operation-type engine, the determined feature vector and the determined operation type associated with the operation. The risk engine may apply functions and/or layers to receive, from the operation-type engine, the determined operation-type confidence score and/or the associated operation-type confidence threshold.

The risk engine may then determine a risk score based on one or more operation features of the feature vector, the determined operation type (as determined by the operation-type engine), one or more operative parameters of the operation (e.g., a maker of the operation, a time of day of initiating the operation, a recipient of the operation, a financial institution associated with the operation, a time of day of executing the operation,), institutional data (e.g., institutional protocols and processes such as internal or regulatory guidelines), and/or historical data (e.g., past operation made by the maker, past operations checked by the one or more checkers, trends in errors made by the maker, trends in making/catching errors by the checker, number of errors in similar operations, rarity of the operation, etc.).

The risk engine may receive the one or more operation features of the feature vector, the determined operation type, one or more operative parameters of the operation, institutional data, and/or historical data from one or more devices, databases, and/or servers. For example, the risk engine may collect data (e.g., the one or more operation records) from the maker client device 106, data (e.g., one or more operative parameters of the operation, institutional data, and/or historical data) from the database 108, and/or data from one or more other servers.

The risk engine may make the determination of the risk score based on various machine-learning techniques and implementations. The risk engine may extract various operation features from the operation data and/or sub-portions of the previously generated operation feature vector, which the risk engine uses to generate the risk score. The analytics server 102 generates the risk score for the operation by applying a trained risk model of the risk engine on the operation feature vector and the operation type. The operation feature vector may be associated with the maker or checker based upon a metadata tag, or the operation feature vector includes identifiers of the maker or the checker as features of the feature vector extracted from the operation data. The analytics server 102 may append the generated risk score to the feature vector of the operation or may save and/or transmit independently of the operation feature vector. In applying the risk engine on the operation feature vector and the determined operation type, the server generates the risk score associated with the operation, such that the outputted risk score indicates a probability that the operation record contains an error and/or a severity of risk to an entity (e.g., a financial institution, a client, a sender, a receiver, etc.) should an error exist in the operation. The risk model may extract various operation features from the feature vector to be used in generating the risk score.

In some embodiments, the analytics server 102 applies the risk engine of the machine-learning architecture to determine the risk score associated with the operation based on the maker of the operation. For example, a maker (e.g., a customer, employee, client, etc.) may initiate a financial operation on the maker client device 106. Using input/output interfaces of the maker client device 106, the maker inputs various data (e.g., operative parameters) associated with the financial operation (e.g., sender of the financial asset, receiver of the financial asset, amount of the financial asset, account details of the sender of the financial asset, account details of the receiver of the financial asset, time of the financial operation, etc.). This data is inputted into an operation record (e.g., an electronic form) and transmitted to the database 108 and/or the analytics server 102. The analytics server receives the operation record (either from the database 108 or the maker client device 106). In some embodiments, the operation record includes additional data not inputted by the maker of the operation (e.g., metadata associated with the maker client device). It should be noted that the operation record may include one or more discreet operation records. The data may include the identity (and associated information) of the maker based on the metadata associated with the maker client device, which may be distinct from the sender/receiver of the financial asset.

The analytics server 102 then applies the risk engine to one or more data including the type of operation, the operation-type confidence score, and the operation record. Through applying various functions and layers of the risk engine (e.g., extraction layer, classifying layers, etc.), the risk engine extracts various features from the feature vector and data from the operation record. This data is used by the risk engine to generate a risk score that indicates the probability that the operation record includes an error. For example, the risk engine may extract from the feature vector the identity of the maker of the operation. The risk engine may then compare that extracted maker identity to historical data associated with various makers. The historical data may include information of how often the various makers create operation records with errors. In the example, the historical data indicates that the maker creates an operation record with an error 50% of the time the maker creates an operation record. In such an example, the risk engine may generate a risk score associated with a high probability of error in the operation record. However, in some embodiments, the risk engine may filter, sort, and/or analyze the historical data to determine more granular interrelated trends relating to errors. For example, in the case in which the maker makes errors 50% of the time, it may be the case that the maker only makes those errors when creating an operation record associated with an operation dispute and has never made an error when making an operation record associated with a transfer of funds. In such an example, the risk engine would generate a risk score associated with a low probability of error in the operation record when the exemplary operation is for a transfer of funds.

Additional, or alternative, attributes of the operation record that may affect the risk score generation may include the time of day that the operation record is created (e.g., operation records in the middle of the night may be associated with higher error rates), change in life status of the maker of the operation record (e.g., operation records created by makers who recently married, divorced, move, had a child, lost a family member, etc., may have higher error rates), rarity of the operation associated with the operation record (e.g., operations that are more rarely performed may have higher error rates), time spent as a maker (e.g., newer employees or clients may have higher error rates), amounts of transfer (e.g., operations with higher amounts may be less or more likely to have higher error rates), etc.

Data extracted by the risk engine from the historical data may be individualized to the maker (or other party associated with the operation) or may be generalized to a population dataset. In some embodiments, the risk engine may adjust the risk score based on a repetitive operation. For example, the risk engine may classify an operation that is repeated (e.g., a monthly subscription, yearly purchase, etc.) as a low-risk operation after the operation has been made more than once.

The routing engine of the machine-learning architecture determines one or more checker routes to which to route the operation for review and authorization, based at least on the one or more operation types associated with the operation (as determined by the operation-type engine) and/or the determined risk score of the operation (as determined by the risk engine). Upon determining a risk score associated with the operation/operation record, the routing engine determines to which one or more checker client devices 104a-104c the operation record will be routed to in order to be authorized for execution or filing. In some embodiments, the routing engine executes the determined routing and transmits the operation record to the determined one or more checker client devices 104a-104c. In some embodiments, the analytics server 102 receives an authorization (or indication of authorization) from the one or more checker client devices 104a-104c to execute the operation associated with the transmitted operation record. The analytics server 102 then transmits instructions to execute the operation associated with the operation record.

In determining which checker client device 104a-104c to route the operation record, the analytics server 102 applies the routing engine to the one or more operation types associated with the operation, the feature vector of the operation, the operation-type confidence level, the generated risk score, institutional data, and/or historical data. The routing engine may generate one or more authorization thresholds upon which to compare the generated risk score from the risk engine. Each authorization threshold may be associated with a checker-routing protocol to follow for operations satisfying the authorization threshold. Non-limiting examples of checker-routing protocols may include routing the operation record to a single checker, multiple checkers, a department checker, the maker, the maker and a second checker, a party associated with the operation, or a quality assurance checker, among others. In some embodiments, the routing engine applies an extracting layer and classifying layer to determine an appropriate checker-routing protocol to execute with the operation record.

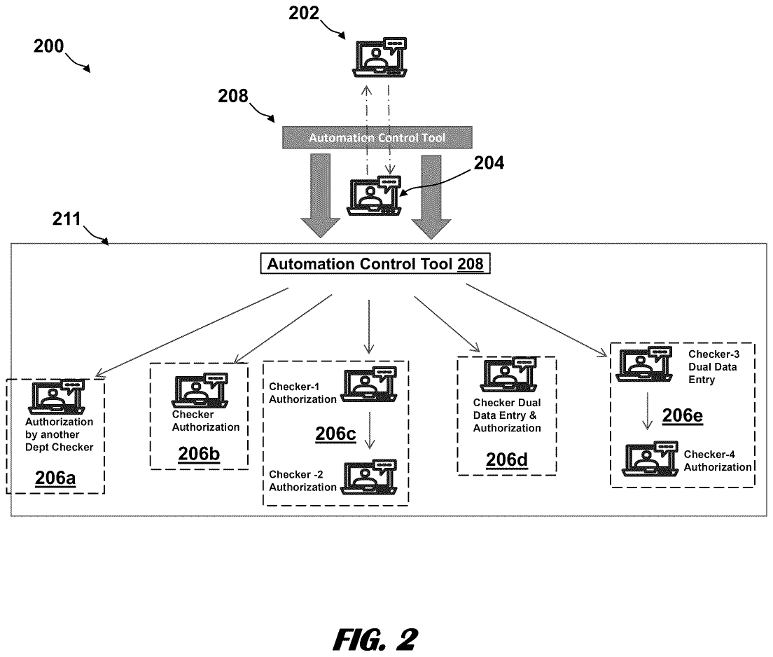

In some embodiments, the output of the routing engine is back fed into the risk engine. For example, the risk score may be updated based on the checker or checkers associated with the checker client devices to which the routing engine determined to route the operation record to. For example, the risk engine may determine that a checker client device to which the operation record should be routed to is associated with a checker that has a history of not catching errors in operation records. The risk engine may apply one or more machine-learning functions or layers to data associated with the checker client device (e.g., error history of a checker associated with the checker client device, etc.) to which the routing engine determines to route the operation record to. In doing so, the risk engine may update the risk score based upon classifying the checker as having a high probability of not catching errors. This updated risk score may be ingested by the routing engine and the routing engine may determine if the updated risk score satisfies a new or previously determined authorization threshold. If the updated risk score satisfies a new authorization threshold, then the routing engine may apply one or more classification layers to determine an updated routing protocol. For example, the routing engine may determine, upon applying one or more classification layers to the updated risk score, the operation record, and/or data associated with the checker client device, to route the operation to an additional checker client device (e.g., applying checker route 206c of FIG. 2). This process may be repeated until the updated risk score does not satisfy a new authorization threshold when applying the routing engine.

FIG. 2 is a block diagram depicting dataflow amongst components of a system 200, according to an exemplary embodiment. The system 200 of the block diagram includes a maker client device 202, a checker client device 204, and an automation control tool 208 including software routines of a machine-learning architecture (e.g., machine-learning architecture of FIG. 1). The checker client device 204 may be one or more electronic devices and may take the form of one or more checker routes 206a-206e. For example, checker route 206a may be authorization by a department checker, checker route 206b may be authorization by a single checker, checker route 206c may be authorization by a first checker and a second checker, checker route 206d may be a dual data entry and authorization checker, and checker route 206e may be a dual data entry and authorization checker followed by a second checker authorization.

In an exemplary embodiment, a maker using the maker client device 202 is associated with a client of a financial institution (though the maker client device 202 may be associated with an employee of the financial institution). The maker initiates an operation on the maker client device 202 by completing an electronic form on the maker client device 202. The maker inputs into the maker client device 202 various operative parameters associated with the operation. The operative parameters (and any associated metadata) are combined into an operation record and are stored in a database (e.g., database 108 of FIG. 1) and/or transmitted to a server 211 (e.g., the analytics server 102 of FIG. 1) hosting the automation control tool 208. The automation control tool 208 then applies a machine-learning architecture (e.g., operation-type engine, risk engine, routing engine) on the transmitted operation record. The machine-learning architecture may include one or more functions and/or layers for manipulating and analyzing various features within the operation record. In one embodiment, the machine-learning architecture extracts data from the operation record and creates a feature vector composed of various features associated with the extracted data.

The automation control tool 208 applies one or more layers of the machine-learning architecture (e.g., the operation-type engine of FIG. 1) to the generated feature vector to determine an operation type of the operation associated with the operation data. The automation control tool 208 then generates a risk score for the operation record by applying functions and layers (e.g., the risk engine of FIG. 1) to the operation data and associated operation type. Upon determining a risk score for the operation record, the automation control tool 208 determines a checker route 206a-206e to which to route the operation record for checking (e.g., authorization or validation). By way of example, an operation record with a low risk score may be routed to checker route 206d. In the checker route 206d, the operation record is transmitted to the maker client device 202 for self-checking by the maker. By way of another example, an operation record with a high risk score may be routed to checker route 206c. In the checker route 206c, the operation record is transmitted to two different checker client devices associated with two different checkers distinct from the maker of the operation record.

### Example Machine-Learning Architecture

Machine learning is a field of study within artificial intelligence that allows computers to learn functional relationships between inputs and outputs without being explicitly programmed. Generally, the term “Artificial Intelligence” refers to a quantitative method, system, or approach (“techniques”) that emulates human intelligence via computer programs. These can be used to make estimates, predictions, recommendations, or decisions in manners that go beyond classical, statistical, mathematical, econometric, or financial approaches. Machine learning derives representations or inferences from data without explicitly programming every parameter representation or computer step (for example, Random Forest or Artificial Neural Network based algorithm approaches). In some cases, AI techniques that are not members of the machine learning subset include techniques such as fuzzy logic, complex dependency parsing techniques for natural language processing.

Machine learning involves a module comprising algorithms that may learn from existing data by analyzing, categorizing, or identifying the data. Such machine-learning algorithms operate by first constructing a model from training data to make predictions or decisions expressed as outputs. In example embodiments, the training data includes data for one or more identified features and one or more outcomes, for example using user maker data-error histories, operation risk criticality (e.g., an operation for committing certain new software modules to a codebase may be comparatively more critical to other software modules; an operation for presenting an account review is comparatively less critical than an operation for transferring funds), and checker device routing labels. Although example embodiments are presented with respect to a few machine-learning algorithms, the principles presented herein may be applied to other machine-learning algorithms.

In general, there are two categories of machine learning problems: classification problems and regression problems. Classification problems, also referred to as categorization problems, aim at classifying items into discrete category values. Training data teaches the classifying algorithm how to classify. In example embodiments, features to be categorized may include operation data, which can be provided to the classifying machine learning algorithm and then placed into categories of, for example, operation-types, operation risk level, or checker device for reviewing a requested operation. Regression algorithms aim at quantifying and correlating one or more features. Training data teaches the regression algorithm how to correlate the one or more features into a quantifiable value.

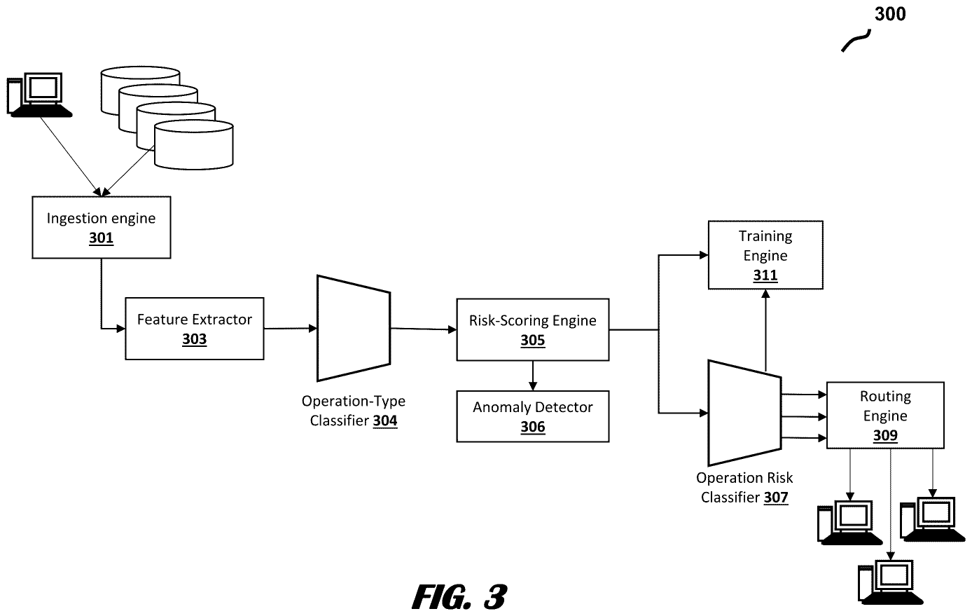

FIG. 3 shows data flow among executable software components of a machine-learning architecture 300, according to an embodiment. The machine-learning architecture 300 may implement a machine-learning pipeline of functions, which may be entirely automated or execute functions of a hybrid machine-learning pipeline, such as human-in-the-loop learning. The machine-learning architecture 300 includes various operations and/or layers that define or function as sub-components of the machine-learning architecture 300, including an ingestion engine 301, a feature extractor 303, an operation-type classifier 304, a risk-scoring engine 305, an anomaly detector 306, an operation risk classifier 307, a routing engine 309, and a training engine 311. Potential embodiments, however, are not so limited and may include any number of additional or alternative software routines, features, functions, and sub-components and still fall within the scope of this disclosure. For ease of description and understanding, the features and functions of the machine-learning architecture 300 are described as being executed by a server computing device, though embodiments are not so limited. In some embodiments, the machine-learning architecture 300 may be a software component of an automation control tool 208 of FIG. 2.

The ingestion engine 301 includes functions for receiving, pre-processing, or otherwise ingesting various types of data for performing the risk-scoring operations. The server or other aspects of the machine-learning architecture 300 may obtain (e.g., receive, retrieve) operation data from a client device (e.g., operation data inputs via a maker device user interface) or from various types of databases (e.g., operation data records from user databases or transaction databases). The server may then feed or input the operation data into the ingestion engine 301. The ingestion engine 301 may receive diverse data formats and data sources, including structured data (e.g., time, account numbers, amounts) and unstructured data (e.g., text instructions, names, addresses), and perform various pre-processing operations that, for example, normalize or standardize the operation data received from the data sources or entered by the maker (or other user) as user inputs entered via a user interface.

The feature extractor 303 includes functions for identifying certain types of data features in the input data and extract the features or feature vectors. Data supplied to the machine-learning architecture 300 generally contains one or more features, which can be described as an individual measurable property of a phenomenon being observed. The concept of feature is related to that of an independent variable used in statistical techniques such as those used in linear regression. The performance of a machine-learning architecture performing operation, such as pattern recognition, classification, or regression is dependent on choosing informative, discriminating, and independent features. Features may comprise numerical data, categorical data, time-series data, strings, graphs, or images. The machine-learning architecture 300 may use or generate an embedding to provide a lower-dimensional representation, such as a feature vector, of the extract features to organize the features based off respective similarities between the features extracted for the operation data of each operation request (or training operation). In some situations, these vectors can become massive. In the case of massive vectors, particular values may become very sparse among a large number of values (e.g., a single instance of a value among 50,000 values). Because such vectors are difficult to work with, reducing the size of the vectors, in some instances, is often necessary. In some embodiments, training engine 311 or other aspect of the machine-learning architecture 300 includes certain functions or features that learn the embeddings along with parameters of a machine-learning model of an engine of the machine-learning architecture 300. In example embodiments, certain types of features of operation data, such as maker identifiers or operation-types, can be mapped to and extracted to form the vectors.

When executing the machine-learning architecture 300, the server may, for example, apply the risk-scoring engine 305 (or other aspects of the machine-learning architecture 300) on the feature vectors extracted for operation data to generate a risk score for the input data. The feature extractor 303 may include functions of a transformer-based encoder, programmed and trained to process and extract relevant features from complex operation data, capturing long-range dependencies, and contextual nuances.

In some implementations, the preprocessing operations of the ingestion engine 301 or the feature extractor 303 executes operations that perform feature-engineering techniques. The feature-engineering techniques may, for example, combine and transform raw data inputs into meaningful features for training a machine-learning model of the machine-learning architecture (e.g., a risk-scoring model of the risk-scoring engine 305).

Optionally, the machine-learning architecture 300 may include an operation-type classifier 304 trained to detect the type of operation, as requested or triggered from the inputs entered at a user interface of a maker client device. As an example, the operation-type classifier 304 determines or predicts the type of operation (e.g., update codebase, transfer of funds, change of beneficiary, financial dispute, updating user profiles) using the features extracted for the operation data (e.g., operation data inputs, operation data records). In some embodiments, the risk-scoring engine 305 generates a risk score for the new operation using the features extracted from the operation data (e.g., feature vector) by the feature extractor 303 and the operation-type outputted by the operation-type classifier 304.

In some embodiments, the server may perform one or more functions for quickly filterin or handling low-risk transactions, thereby reducing AI processing load and human workload. For example, in some implementations, the server may be preconfigured to determine that certain types of operations are low-risk and need not apply the machine-learning architecture 300 on the operation request. In such implementations, the server may detect certain type of input data in the operation request or operation data and determine that the operation-type is a low-risk or automatically permissible operation. As another example, in some implementations, the server may be similarly preconfigured to determine that certain types of operations are low-risk and need not apply the machine-learning architecture 300 on the operation request, where the operation-type classifier 304 determines that the type of operation is a low-risk or automatically permissible operation.

The risk-scoring engine 305 includes functions for generating or otherwise assigning risk scores to operations based on a multi-factor machine-learning model. The machine-learning model of the risk-scoring engine 305 is trained to generate the risk score for a given data input, typically a feature vector extracted for various types of data or information associated with an operation. The types of data or information may include operation characteristics (amount, time, type, location, etc.), behavioral patterns (previous operation pattern), and various types of external data from third-party databases (e.g., credit scores from third-party user databases; fraudster indicator data from fraud detection databases), among other types of data forming the feature vectors.

The anomaly detector 306 includes functions and layers of the machine-learning architecture 300 for identifying unusual patterns and deviations from expected norms using various machine-learning techniques, such as isolation forests, one-class support vector machines (SVMs), and Gaussian mixture models (GMMs), among others. Anomaly detection functions (sometimes referred to as “outlier detection”) or machine-learning models of the anomaly detector 306 are trained to identify or detect the data points (e.g., features, feature vectors) that deviate from an expected pattern. The detected anomaly in the data may indicate, for example, instances of errors in software code, data entry errors, fraud, or other outliers anomalous from an expected norm.

In some implementations, the anomaly detector 306 or other component of the machine-learning architecture 300 implements clustering and anomaly grouping. Using the outputs of the clustering or anomaly grouping functions, the anomaly detector 306 or the other software component(s) of the machine-learning architecture 300 may perform pattern-based investigations for determining or identifying expected patterns or identifying certain forms of outliers (e.g., uncovering potential fraudsters having patterns of feature or feature vectors).

In one example embodiment, the anomaly detector 306 or training engine 311 implements K-means clustering for clustering similar features of operation data to identify patterns. KMC assumes data points have implicit shared characteristics and “clusters” data within a centroid or “mean” of the clustered data points. During training the anomaly detector 306 by the training engine 311, KMC adds a number of k centroids and optimizes the position around clusters. This process is iterative, where each centroid, initially positioned at random, is re-positioned by the training engine 311 and the anomaly detector 306 towards the average point of a cluster. This process concludes when the anomaly detector 306 positions the centroids such that the centroids reach an optimal position within a cluster. The training engine 311 typically employs unsupervised training to trains the anomaly detector 306 using KMC. In example embodiments, operation data or maker and checker histories are used to train the centroids of a KMC machine-learning model of the anomaly detector 306, which, after training, is used to estimate whether the operation data of a requested operation exceeds a threshold distance from a cluster and thus represents an outlier or anomalous operation data.

As another example embodiment, the anomaly detector 306 or training engine 311 implements K-Nearest Neighbor (KNN). Generally, KNN shares similar characteristics to KMC. For example, KNN assumes data points near each other share similar characteristics and computes the distance between data points to identify those similar characteristics but instead of k centroids, KNN uses k number of neighbors. The k in KNN represents how many neighbors will assign a data point to a class, for classification, or object property value, for regression. Selection of an appropriate number of k is integral to the accuracy of KNN. For example, a large k may reduce random error associated with variance in the data but increase error by ignoring small but significant differences in the data. Therefore, a careful choice of k is selected to balance overfitting and underfitting. Concluding whether some data point belongs to some class or property value k, the distance between neighbors is computed. Common methods to compute this distance are Euclidean, Manhattan or Hamming to name a few. In some embodiments, neighbors are given weights depending on the neighbor distance to scale the similarity between neighbors to reduce the error of edge neighbors of one class “out-voting” near neighbors of another class. In one example embodiment, k is 1 and a Markov model approach is utilized. In example embodiments, operation data or maker and checker histories are used to train the centroids of a KMC machine-learning model of the anomaly detector 306, which, after training, is used to estimate whether the operation data of a requested operation exceeds a threshold distance from a cluster and thus represents an outlier or anomalous operation data.

Optionally, an operation risk classifier 307 may be trained to predict or classify a level of risk associated with an operation. The server may execute the operation risk classifier 307 on various data inputs for the operation, such as risk score, the feature vector, or an anomaly score output, among others, to output a risk classification. The operation risk classifier 307 may output the level of risk as a numerical value or other data representation, such as text or color images, based upon comparing the various data inputs against one or more risk classification thresholds. As a simple example, the operation risk classifier 307 may compare the risk score against one or more threshold values to determine the level of risk.

The routing engine 309 includes functions for routing the operation data and operation request to a particular checker client device. After the risk-scoring engine 305 determines and generates the risk score for the operation, the operation risk classifier 307 may determines one or more authorization thresholds to use in determining a level of risk. The routing engine 309 is trained to determine which checker client devices to route the operation record data for review. For example, when the risk score of the operation is above a specific authorization threshold, the routing engine 309 may transmit the operation data to a particular checker client device for reviewing the high-risk operations or particular types of operations. In some embodiments, the routing engine 309 may be trained to route operation requests according to various types of prioritization features, such that the routing engine 309 prioritizes transactions for human-checker reviews. Non-limiting examples of prioritization features include impact, time-sensitivity, threshold amounts or values, account or operation sensitivity, and AI confidence scores, among others.

The training engine 311 may continuously retrain or adjust the routing engine 309 according to feedback inputs received from administrative users or checkers, where the feedback inputs indicate (to the training engine 311) whether the routing engine 309 correctly routed the operation to the correct checker device or correctly determined that no checker device needed to review the operation request data. In some implementations, the training engine 311 may continuously retrain or tune the parameters of the routing engine 309 by executing a reinforced learning function.

The training engine 311 executes software functions for training the various functional engines of the machine-learning architecture 300. The training engine 311 may execute various machine-learning functions or algorithms that adjust or tune parameters or weights of the various engines of the machine-learning architecture 300, allowing the machine-learning models of the various engines to learn from existing operation data by analyzing, categorizing, or identifying certain features or patterns of the operation data.

In example embodiments, training engine 311 may execute various machine-learning techniques and functions for training the engines of the machine-learning architecture 300, such as unsupervised learning, supervised learning, semi-supervised learning, reinforcement learning, transfer learning, incremental learning, curriculum learning techniques, and learning to learn, among others. The training operation data is fed by the server into the machine-learning architecture 300 to teach the machine learning engine; such training data may include training operation data and include features, such as user or maker's interaction histories, and may indicate or include the respective target output data, such as whether a requested operation is high risk or low risk, whether the operation data should be reviewed by a checker at a check client device, and/or which checker client device the machine-learning architecture should route the operation data to for further review.

In some embodiments, training engine 311 trains the various engines of the machine-learning architecture using semi-supervised learning. Semi-supervised learning can involve providing all or a portion of training data that is partially labeled to a machine learning model of the given engine of the machine-learning architecture 300. During semi-supervised learning, the training engine 311 implements supervised learning for a portion of labeled training data and implements unsupervised learning for a portion of unlabeled training data. In some embodiments, the training engine 311 implements reinforcement learning. Reinforcement learning can involve first providing all or a portion of the training data to a machine learning module and as the machine learning module produces an output, the machine learning model of a given engine of the machine-learning architecture 300 receives a feedback (or “reward”) signal in response to a correct output. Typically, the reward signal is a numerical value and the machine learning model is developed to maximize the numerical value of the reward signal. In addition, reinforcement learning can adopt a value function that provides a numerical value representing an expected total of the numerical values provided by the reward signal over time.

In some embodiments, the training engine 311 trains one or more engines of the machine-learning architecture 300 using a continuous or learning-to-learn function for continuously training the machine-learning architecture 300 and/or identifying meaningful discriminating features within operation data. Learning-to-learn, or meta-learning, comprises, in general, two levels of learning: quick learning of a single task and slower learning across many tasks. As an example, the training engine 311 may first train a first set of parameters or weights of a machine learning model of a particular engine of the machine-learning architecture 300. During or after operation of the first trained machine learning model, the training engine 311 may adjust or tune the parameters or weights according to the machine learning operations of the training engine 311. The training engine 311 may execute this process iteratively on the success (received as feedback inputs) of the particular machine learning engine. In another example, an optimizer function of the machine-learning architecture 300, or another machine learning model of the machine-learning architecture 300, is used wherein the output of a first trained machine learning model of a particular engine is fed to the optimizer, which constantly learns and returns the final results. Other techniques for training the machine learning module and/or trained machine learning module are possible as well.

In some cases, the operating input data can include data from a computing device executing a trained machine learning module and/or input data from one or more computing devices. In example embodiments, the training engine 311 can use results or user inputs as input feedback for retraining or tuning certain machine-learning models of corresponding engines of the machine-learning architecture 300. A trained machine learning model can also rely on past results as inputs for generating new results. In example embodiments, operation data can comprise maker or checker data entry or accuracy histories and, when provided to the training engine 311, results in output data.

### Example Processes

FIG. 4 shows steps of a method 400 for implementing one or more machine-learning architectures for generating risk scores of maker-initiated operations (“operations”) and routing the operations to one or more checkers, based at least on the generated risk score. Embodiments may include additional, fewer, or different operations than those described in the method 400. The method 400 is performed by a server (e.g., analytics server 102 of FIG. 1) executing machine-readable software code, though it should be appreciated that the various operations may be performed by one or more computing devices and/or processors.

The server executes the machine-learning architecture comprising layers or functions defining an operation-type engine, a risk engine, and/or a routing engine, among other potential sub-component engines, layers, or functions of the machine-learning architecture. In some embodiments, the machine-learning architecture constitutes multiple, distinct machine-learning architectures. In some embodiments, the machine-learning architecture includes a single machine-learning architecture. For ease of description, the machine-learning architecture of the method 400 constitutes the single machine-learning architecture. The server executes the software routines of the layers and functions of the machine-learning architecture in various operational phases, including a training phase, a deployment phase (sometimes referred to as the “inference phase” or “production phase”), and an optional enrollment phase (not shown in the example method 400).

In step 401, the server obtains one or more operation records for an operation from one or more data sources through one or more input layers. These operation records may include various data associated with the operation such as data relating to one or more types of operations associated with the operation, operative parameters of the operation, and/or historical data.

The operation records may include data associated with the operation's type (e.g., financial, non-financial, etc.). For example, the operation records may be obtained by one or more input layers and may include explicit operation type data relating to the operation. This data may be inputted by a maker of the operation on a form or field. For example, when initiating an operation, a maker may select a specific operation the maker would like to execute (e.g., a money transfer, a dispute of charges, a change of beneficiary, etc.). In other embodiments, this data may be automatically inputted into the one or more operation records by a second server hosting an electronic form with which the maker is initiating the operation. For example, the second server may automatically input an operation type for the operation based on the maker's inputs or based on how/from where the maker accessed the electronic form (e.g., from a specific webpage).

The operation records may also include data associated with operative parameters of the operation. For example, the operative parameters of the operation may include data related to the operation type, the operation maker, an operation amount, an operation receiver, an operation sender, a financial institution receiving the operation, a financial institution sending the operation, a time period associated with the operation, a time of day of the operation's initiation, a time of day of the operation's execution, personally identifiable information related to one or more parties to the operation (e.g., full name, social security number, driver's license number, passport number, email address, physical address, phone number, date of birth, and biometric information such as fingerprints or facial recognition data, credit card numbers, bank account details, personal health information), account details of the operation, educational information associated with one or more parties to the operation, among others. This data may be input by the maker of the operation (e.g., into the electronic form). Additionally, or alternatively, the operative parameters of the operation may be hosted in one or more databases (e.g., database 108) to which the server may access (e.g., a client/customer/personnel database of an institution). These one or more databases may be publicly accessible or privately accessible. Additionally, or alternatively, the server may obtain this data from one or more other servers, or one or more other electronic devices.

The operation records may also include data associated with historical data. For example, the historical data may include data related to errors of the maker and/or checker of the operation in previously made operations, errors may by others in similar operations, number of executed operations similar to the operation, number of previously made/checked operations by the maker/checker, number of similar operations made/checked by the maker/checker, and number of errors based on time of day of initiating/checking/executing operations, among others. The server may obtain (retrieve) this data from one or more databases (e.g., database 108), one or more other servers, or one or more other electronic devices. In one non-limiting embodiment, the server obtains historical error data, wherein the historical error data is data associated with past errors made in operations.

Historical error data may be filtered, combined, parsed, and/or otherwise categorized to determine trends and general overviews of potential errors. For example, the error data may show trends of a maker/checker towards making more or less errors over time. Likewise, the historical data may combine trends of errors of a population. For example, the historical data may include error statistics of makers/checkers over time. The server may obtain (retrieve) historical data (error or otherwise) from one or more databases (e.g., database 108), one or more other servers, or one or more other electronic devices.

In step 403, the server extracts a feature vector for the operation based upon a plurality of operation features, the operation features extracted using the one or more operation records for the operation. In some embodiments, this extraction may be done by a trained extractor. In some embodiments, the one or more operation records are ingested into the machine-learning architecture of method 400. The server extracts relevant operation features from the ingested operation records and then filters and/or sorts the extracted operation features into a representative feature vector indicative of the operation. The extracted feature vector is then saved either locally or remotely to the sever (e.g., database 108 of FIG. 1).

In step 405, the server determines an operation type for the operation by applying a classifier of a machine-learning architecture (e.g., the operation-type engine of FIG. 1) on the feature vector for the operation. The server applies a classifier (e.g., an operation-type classifier) to determine the operation type based on one or more operation features of the feature vector. In some embodiments, the feature vector of the operation includes an explicit operation-type feature. In such embodiments, the classifier identifies and classifies the operation based on the single, explicit operation-type feature. In other embodiments, the classifier identifies and classifies the operation based on more than one operation features. This classifier may identify common operation features across common operation types and apply one or more classifying functions to identify and classify the operation based on a presence and/or absence of common operation features. In some embodiments, an operation extractor is applied to the feature vector of the operation to extract one or more relevant features for determining the operation type.

In step 407, the server generates a risk score for the operation by applying a risk model of the machine-learning architecture on the operation feature vector and the operation type. The generated risk score may be appended to the feature vector of the operation or may be saved and/or transmitted independently of the operation feature vector. In applying the risk model (e.g., the risk engine of FIG. 1) on the feature vector and the determined operation type, the server generates a risk score associated with the operation, the risk score being associated with a probability that the operation record contains an error and/or a severity of risk to an entity (e.g., a financial institution, a client, a sender, a receiver, etc.) should an error exist in the operation. The risk model may extract various operation features from the feature vector to be used in generating the risk score.

The risk model may determine the risk score based on one or more operation features of the feature vector. For example, the risk score may be based on the operation type, one or more operative parameters of the operation, historical data (e.g., error data associated with one or more features of the operation), a maker of the operation, a time of day of initiating the operation, a recipient of the operation, a financial institution associated with the operation, a time of day of executing the operation, a rarity of the operation, etc. In one embodiment, the risk model may obtain additional historical data associated with one or more operation features of the operation to supplement the feature vector of the operation in determining the risk score.

Additionally, or alternatively, the risk score may be generated based on an abnormality in the feature vector of the operation record. For example, if an operation feature (e.g., sender, recipient, amount, date, etc.) is determined to be abnormal to a population of operation data (e.g., training data, historical data, etc.), the risk model may flag the operation and classify the operation as a high risk. In some embodiments, the risk model classifies the operation in discreet risk score categories. In other embodiments, the risk score generates a risk score on a continuum of risk scores.

In some embodiments, the risk score is not associated with a likelihood of error in the operation record. For example, in one non-limiting example, the risk score may be generated based on the severity of impact an error in the operation may have on a party associated with the operation. For example, in an operation of $100 from a sender to receiver, each with a net worth of over $1,000,000, the potential impact on the parties is relatively minor should there be an error in the associated operation record. In such an example, the risk model may generate a low risk score for the operation. This low risk score may be independent of the likelihood of error based on the maker or checker of the operation. In a similar example, an operation of $100 from a sender to a receiver, each with a net worth of $100, the potential impact on the receiver may be relatively substantial if there is an error in the operation record. In such an example, the risk model may generate a high risk score for the operation. This high risk score may be attributed to the operation independent of the likelihood of error. However, it should be understood that the risk score may be generated based on the likelihood of error, the potential impact on the parties, a combination of the two, or any other suitable basis for the risk score.

In step 409, the server determines one or more authorization thresholds for the authorization based upon the risk score. Upon determining and generating the risk score for the operation, the server determines one or more authorization thresholds to use in determining to which checker client devices to route the operation record. For example, when the risk score of the operation is above a specific authorization threshold, the operation is automatically routed through to a checker route (e.g., checker routes 206a-206e of FIG. 2) associated with the specific authorization threshold. In some embodiments, the server accesses various preconfigured authorization thresholds stored in a database (e.g., database 108 of FIG. 1) to apply to the risk score. In such embodiments, an institution (e.g., a financial institution, regulatory body, standard creator) prescribes various checking protocols for authorizing an operation after a maker initializes the operation. For example, the institution may prescribe that any operation above a specific threshold (e.g., $10,000) must go through a two-checker protocol. In another example, the institution may prescribe that any operation record created by a maker with an error rate (e.g., percentage of initiated operations with an error) above a specified threshold (e.g., 10% error rate) must be routed through a two-checker protocol. The prescribed checking protocols may be based on any operation feature (or combination thereof) of the feature vector of the operation. In some embodiments, the checking protocols are associated with authorization thresholds which correlate with the risk scores generated in step 407. For example, specific checking protocols are associated with specific authorization thresholds. In one example, as the risk score increases, more stringent checking protocols may be applied (e.g., increasing from a single-checker authorization to a double-checker authorization once the risk score increases above a specific threshold).

In other embodiments, the one or more authorization thresholds are predicted or determined by a machine-learning architecture trained on historical data. In such cases the institution does not explicitly prescribe the authorization thresholds in a database or other storage location. In this embodiment, the server executes the machine-learning architecture to determine the risk scores associated with a checking protocol.

In step 411, the server transmits the operation record to one or more client devices corresponding to the one or more authorization thresholds. According to an exemplary embodiment, the server compares the generated risk score to the one or more authorization thresholds to determine an appropriate checking protocol to execute. Each checking protocol (e.g., checker route) may be associated with one or more client devices to which the operation may be routed (e.g., transmitted) to in the event that the associated risk score satisfies the associated authorization threshold. Upon determining an appropriate checking protocol (and associated client devices), the server automatically transmits the one or more operation records to the one or more client devices for authorization of the operation. It should be noted that the one or more operation records may be directly transmitted to the one or more client devices based by the server. However, the one or more client devices may alternatively access the one or more operation records from a database (e.g., database 108 of FIG. 1), one or more other servers, or one or more other electronic devices.

FIG. 5 shows steps of a method 500 for training one or more machine-learning architectures to generate risk scores of maker-initiated operations (“operations”) and subsequently routing the operations to one or more checkers based at least on the generated risk score. Embodiments may include additional, fewer, or different operations than those described in the method 500. The method 500 is performed by a server executing machine-readable software code of the neural network architectures, though it should be appreciated that the various operations may be performed by one or more computing devices and/or processors.

In some embodiments, the steps and processes of method 500 are substantially similar to the steps and processes of method 400, but with training records for training the one or more machine-learning architectures. In some embodiments, the server and machine-learning architectures of method 500 are the same server and machine-learning architectures of method 400. The server may receive both training data (for training the machine-learning architecture) and/or operation records (for generating a risk score and routing the operation record). The training data may include one or more training labels with which the server may compare the predicted risk score and routing as determined in method 500. In one embodiment, the training labels may include an authorization or rejection of the operation record by the checker. This may authorization or rejection may be used to label the operation and be applied to the loss layer to further train the machine-learning architecture. In executing method 500, the sever may additionally apply one or more loss layers to perform loss functions and update hyper-parameters and/or weights of the machine-learning architectures. In some embodiments, each of the sub-component engines (e.g., embedding extractor, language classifier) comprises distinct loss layers, which separately train the particular sub-component engine. In some embodiments, the machine-learning architecture includes fused loss layers that collectively train the sub-component engines (e.g., embedding extractor, language classifier).

According to an embodiment, both operation records and training records may be routed to checkers (e.g., on an 80/20 basis) to further train the machine-learning architecture. In such embodiments, the checker is unaware which records are operations and which are training records. The checker labels each record (whether operation or training), and the label is used by the one or more loss layers to compare the predicted output to the checker label and adjust one or more hyper-parameters based on the relative similarity of the predicted and actual output. This training may continue until the relative similarity for the training phase satisfies a training threshold.

In step 501, the server obtains one or more training records for an operation from one or more data sources. For example, the server may receive the one or more training records from any number of sources, including other server, electronic devices, or databases. In some embodiments, the server applies the machine-learning architecture extract the one or more training records from a data source.

In step 503, the server extracts a feature vector for the operation based upon a plurality of operation features, the operation features extracted using the one or more training records for the operation. In some embodiments, this extraction may be done by an extractor. In some embodiments, the one or more training records are ingested into the machine-learning architecture of method 500. The server extracts relevant operation features from the ingested training records and then filters and/or sorts the extracted operation features into a representative feature vector indicative of the operation. The server may extract the relevant operation features by applying the extractor to the obtained training records. The extracted feature vector is then saved either locally or remotely to the sever (e.g., database 108 of FIG. 1).

In step 505, the server determines an operation type for the operation by applying a classifier of a machine-learning architecture on the feature vector for the operation. The server applies a classifier (e.g., an operation-type classifier) to determine the operation type of the operation based on one or more operation feature of the feature vector. In some embodiments, the feature vector of the operation includes an explicit operation feature. In such embodiments, the classifier identifies and classifies the operation based on the single, explicit operation feature. In other embodiments, the classifier identifies and classifies the operation based on more than one operation features. This classifier may identify common operation features across common operation types and apply one or more classifying functions to identify and classify the operation based on a presence and/or absence of common operation features. In some embodiments, an operation extractor is applied to the feature vector of the operation to extract one or more relevant features for determining the operation type.

In step 507, the server generates a risk score for the operation by applying a risk model of the machine-learning architecture on the operation feature vector and the operation type. The generated risk score may be appended to the feature vector of the operation or may be saved/transmitted independently of the feature vector. In applying the risk model (e.g., a risk engine) on the operation feature vector and the operation type, the server generates a risk score associated with the operation, the risk score being associated with a risk that the training record contains an error and/or a severity of risk to an entity (e.g., a financial institution, a client, a sender, a receiver, etc.) should an error exist in the operation. The risk model may extract various operation features from the feature vector to be used in generating the risk score.

The risk model may determine the risk score based on one or more operation features of the feature vector. For example, the risk score may be based on the operation type, one or more operative parameters of the operation, historical data (e.g., error data associated with one or more features of the operation), a maker of the operation, a time of day of initiating the operation, a recipient of the operation, a financial institution associated with the operation, a time of day of executing the operation, a rarity of the operation, etc. In one embodiment, the risk model may obtain additional historical data associated with one or more operation features of the operation to supplement the feature vector of the operation in determining the risk score.

Additionally, or alternatively, the risk score may be generated based on an abnormality in the feature vector of the operation record. For example, if an operation feature (e.g., sender, recipient, amount, date, etc.) is determined to be abnormal to a population of operation data (e.g., training data, historical data, etc.), the risk model may flag the operation and classify the operation as a high risk. In some embodiments, the risk model classifies the operation in discreet risk score categories. In other embodiments, the risk score generates a risk score on a continuum of risk scores.

In step 509, the server determines one or more authorization thresholds for the authorization based upon the risk score. Upon determining and generating the risk score for the operation, the server determines one or more authorization thresholds to use in determining to which checker client devices to route the operation. For example, when the risk score of the operation is above a specific authorization threshold, the operation is automatically routed to a checker route (e.g., to one or more specific client device(s) 104a-104c of FIG. 1) associated with the specific authorization threshold.

In some embodiments, the server accesses various preconfigured authorization thresholds stored in a database (e.g., database 108 of FIG. 1) to apply to the risk score. In such embodiments, an institution (e.g., a financial institution, regulatory body, standard creator) prescribes various checking protocols for authorizing an operation after a maker initializes the operation. For example, the institution may prescribe that any operation above a specific threshold (e.g., $10,000) must go through a two-checker protocol. In another example, the institution may prescribe that any operation records created by a maker with an error rate (e.g., percentage of initiated operations with an error) above a specified threshold (e.g., 10% error rate) must be routed to two checker client devices. The prescribed checking protocols may be based on any operation feature (or combination thereof) of the feature vector of the operation. In some embodiments, the checking protocols are associated with authorization thresholds which correlate with the risk scores generated in step 407. For example, specific checking protocols are associated with specific authorization thresholds. In one example, as the risk score increases, more stringent checking protocols may be applied (e.g., increasing from a single-checker authorization to a double-checker authorization once the risk score increases above an authorization threshold).

In step 511, the server predicts one or more client devices corresponding to one or more authorization thresholds to which to transmit the training record. This may be done in a method substantially similar to step 411 of FIG. 4. In some embodiments, the predicted one or more client devices is then compared against one or more training labels. A loss layer may be applied to determine a distance between the predicted output and an actual output (as defined by the one or more training labels). This distance may then be used by the server to update/adjust the hyper-parameters of the machine-learning architecture to train the models, engines, layers, and/or functions of the machine learning architecture.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A computer-implemented method comprising:
training, by a computer, parameters of a routing engine of a machine-learning architecture for routing operation data to one or more computing device according to a risk score using historical operation data associated with maker identifiers;
obtaining, by the computer, a request for an operation and operation data inputs via a user interface of a maker client device associated with a maker identifier;
obtaining, by the computer, one or more operation data records associated with the operation indicated by the request from one or more data sources;
extracting, by the computer, a feature vector for the operation based upon a plurality of operation features extracted using the operation data including the one or more operation data records, the maker identifier, and the operation data inputs for the operation;
determining, by the computer, an operation-type for the operation by applying a classifier of the machine-learning architecture on the feature vector for the operation;
generating, by the computer, the risk score for the operation by executing a risk-scoring engine of the machine-learning architecture on the feature vector based on the maker identifier and the operation-type of the operation;
generating, by the computer, an anomaly score by executing an anomaly detector of the machine-learning architecture on the feature vector based on the maker identifier and the operation-type of the operation, the anomaly score indicating a likelihood that the operation data represents an anomalous operation request;
determining, by the computer, one or more authorization thresholds for the operation based upon the risk score, the anomaly score, and the operation-type;
transmitting, by the computer, the operation data to a first checker client device corresponding to the one or more authorization thresholds based on the risk score and the anomaly score by executing the routing engine trained for routing the operation data to the one or more computing devices based upon the risk score and the anomaly score generated using the maker identifier;
in response to a determination from the first checker client device indicating that the operation is a rejected operation:
retraining, by the computer, the routing engine of the machine-learning architecture by adjusting one or more parameters of the routing engine according to the indication that the operation is the rejected operation having an error associated with the maker identifier;
transmitting, by the computer, next operation data of a next operation to a second checker client device based upon a second risk score and a second anomaly score generated using for the next operation received from the maker client device associated with the maker identifier; and
executing, by the computer, the next operation using the next operation data from the maker client device, responsive to the computer receiving an indication of authorization for the next operation from the second checker client device.

2. The computer-implemented method of claim 1, further comprising receiving, by the computer from a maker client device, one or more maker inputs indicating the one or more operation records for the operation.

3. The computer-implemented method of claim 1, further comprising training, by the computer, the classifier of the machine-learning architecture to determine the operation type by applying the classifier of the machine-learning architecture on a plurality of historic operation records, each historic operation record having a training label indicating the operation type.

4. (canceled)

5. The computer-implemented method of claim 1, wherein the computer applies a risk model of the machine-learning architecture on historical data to generate the risk score, wherein the historical data includes error data associated with one or more operation features of the feature vector.

6. The computer-implemented method of claim 1, wherein the computer applies a routing model of the machine-learning architecture on historical data and the risk score to determine the one or more authorization thresholds.

7. The computer-implemented method of claim 1, wherein the risk score indicates at least one of a probability of one or more errors in the one or more operation records or a level of risk associated with the operation.

8. A system comprising:
a server comprising a processor for executing machine-readable instructions, the server configured to:
train parameters of a routing engine of a machine-learning architecture for routing operation data to one or more computing device according to a risk score using historical operation data associated with maker identifiers;
obtain a request for an operation and operation data inputs via a user interface of a maker client device associated with a maker identifier;
obtain one or more operation data records associated with the operation indicated by the request from one or more data sources;
extract a feature vector for the operation based upon a plurality of operation features extracted using the operation data including the one or more operation data records, the maker identifier, and the operation data inputs for the operation;
determine an operation-type for the operation by applying a classifier of the machine-learning architecture on the feature vector for the operation;
generate the risk score for the operation by executing a risk-scoring engine of the machine-learning architecture on the feature vector based on the maker identifier and the operation-type of the operation;
generate an anomaly score by executing an anomaly detector of the machine-learning architecture on the feature vector based on the maker identifier and the operation-type of the operation, the anomaly score indicating a likelihood that the operation data represents an anomalous operation request;
determine one or more authorization thresholds for the operation based upon the risk score, the anomaly score, and the operation-type;
transmit the operation data to a first checker client device corresponding to the one or more authorization thresholds based on the risk score and the anomaly score by executing the routing engine trained for routing the operation data to the one or more computing devices based upon the risk score and the anomaly score generated using the maker identifier; and
in response to a determination from the first checker client device indicating that the operation is a rejected operation:
retrain the routing engine of the machine-learning architecture by adjusting one or more parameters of the routing engine according to the indication that the operation is the rejected operation having an error associated with the maker identifier;
transmit next operation data of a next operation to a second checker client device based upon a second risk score and a second anomaly score generated using the maker identifier for the next operation received from the maker client device associated with the maker identifier; and
execute the next operation using the next operation data from the maker client device, responsive to receiving an indication of authorization for the next operation from the second checker client device.

9. The system of claim 8, wherein the server is further configured to receive, from a maker client device, one or more maker inputs indicating the one or more operation records for the operation.

10. The system of claim 8, wherein the server is further configured to train the classifier of the machine-learning architecture to determine the operation type by applying the classifier of the machine-learning architecture on a plurality of historic operation records, each historic operation record having a training label indicating the operation type.

11. (canceled)

12. The system of claim 8, wherein the server is configured to apply a risk model of the machine-learning architecture to historical data to generate the risk score, wherein the historical data includes error data associated with one or more of operation features of the feature vector.

13. The system of claim 8, wherein the server is configured to apply a routing model of the machine-learning architecture is applied to historical data and the risk score to determine the one or more authorization thresholds.

14. The system of claim 8, wherein the risk score indicates at least one of a probability of one or more errors in the one or more operation records or a level of risk associated with the operation.

15. A computer-readable medium comprising a non-transitory storage memory configured to store machine-readable instructions that when executed by a processor instruct the processor to:
train parameters of a routing engine of a machine-learning architecture for routing operation data to one or more computing device according to a risk score using historical operation data associated with maker identifiers;
obtain a request for an operation and operation data inputs via a user interface of a maker client device associated with a maker identifier;
obtain one or more operation data records associated with the operation indicated by the request from one or more data sources;
extract a feature vector for the operation based upon a plurality of operation features extracted using the operation data including the one or more operation data records, the maker identifier, and the operation data inputs for the operation;
determine an operation-type for the operation by applying a classifier of the machine-learning architecture on the feature vector for the operation;
generate the risk score for the operation by executing a risk-scoring engine of the machine-learning architecture on the feature vector based on the maker identifier and the operation-type of the operation;
generate an anomaly score by executing an anomaly detector of the machine-learning architecture on the feature vector based on the maker identifier and the operation-type of the operation, the anomaly score indicating a likelihood that the operation data represents an anomalous operation request;
determine one or more authorization thresholds for the operation based upon the risk score, the anomaly score, and the operation-type; and
transmit the operation data to a first checker client device corresponding to the one or more authorization thresholds based on the risk score and the anomaly score by executing the routing engine trained for routing the operation data to the one or more computing devices based upon the risk score and the anomaly score generated using the maker identifier; and
in response to a determination from the first checker client device indicating that the operation is a rejected operation:
retrain the routing engine of the machine-learning architecture by adjusting one or more parameters of the routing engine according to the indication that the operation is the rejected operation having an error associated with the maker identifier;
transmit next operation data of a next operation to a second checker client device based upon a second risk score and a second anomaly score generated using the maker identifier for the next operation received from the maker client device associated with the maker identifier; and
execute the next operation using the next operation data from the maker client device, responsive to receiving an indication of authorization for the next operation from the second checker client device.

16. The computer-readable medium of claim 15, the processor further instructed to receive, from a maker client device, one or more maker inputs indicating the one or more operation records for the operation.

17. The computer-readable medium of claim 15, the processor further instructed to train the classifier of the machine-learning architecture to determine the operation type by applying the classifier of the machine-learning architecture on a plurality of historic operation records, each historic operation record having a training label indicating the operation type.

18. (canceled)

19. The computer-readable medium of claim 15, the processor further configured to apply a risk model of the machine-learning architecture on historical data to generate the risk score, wherein the historical data includes error data associated with one or more of operation features of the feature vector.

20. The computer-readable medium of claim 15, wherein the risk score is associated with a probability of one or more errors in the one or more operation records.
